(19) United States
(12) Patent Application Publication
(10) Pub. No.: US 2024/0193446 A1
(43) Pub. Date: Jun. 13, 2024

(54) COMPUTER-IMPLEMENTED SYSTEMS AND METHODS FOR ROBUST CONFIDENCE INTERVAL ANALYSIS

(71) Applicant: Minitab, LLC, State College, PA (US)

(72) Inventors: Senin J. Banga, State College, PA (US); Cheryl L. Pammer, San Diego, CA (US)

(73) Assignee: Minitab, LLC, State College, PA (US)

(21) Appl. No.: 18/078,480

(22) Filed: Dec. 9, 2022

(51) Int. Cl. G06N 7/01

(52) U.S. Cl. CPC G06N 7/01

(57) ABSTRACT

A computing device reads, a dataset representative of a plurality of distribution agnostic manufacturing measurements, the dataset includes a plurality of observations. Each observation includes a response variable value and a plurality of explanatory variable values. The instructions further cause the computer system to fit a linear regression solver to the dataset to express the response variable value as a function of the explanatory variables; compute a sample coefficient of multiple determination based on the function; compute a kurtosis of a sample of fitted values; and output, a one- or two-sided robust confidence interval for a corresponding population coefficient of multiple determination that is insensitive to normality.

### BACKGROUND

### Technical Field

The present disclosure generally relates to confidence interval methods, and more particularly, to improved fabrication methods using confidence intervals for a population coefficient of multiple determination in regression models with non-normal random regressors.

### Description of the Related Art

Statistical models may be used to analyze existing systems and processes. For example, a manufacturing process typically involves repetitions of fabrication processes that produce an article of manufacture by transforming an object from one state to another. For example, a glass manufacturing site may melt and refine raw materials in a series of repeatable processes to produce a final manufactured glass item. For quality assurance, properties of different batches of processed raw materials may be required to be within predefined ranges in each stage. Classical regression models may be used for analyses of these processes or stages.

### SUMMARY

In one aspect, a method is disclosed that includes reading, by a computing device, a dataset representative of a plurality of distribution agnostic measurements, the dataset includes a plurality of observations, each observation including a response variable value and a plurality of explanatory variable value. The method includes fitting, by the computing device, a regression solver to the dataset to describe (or express) the response variable values as a function of the explanatory variables, a so-called regression equation, computing, by the computing device, a sample coefficient of multiple determination based on the function, computing by the computing device, a kurtosis of a sample of fitted values and outputting, by the computing device, a one- or two-sided confidence interval for a population coefficient of multiple determination. The computing device may be a confidence interval procedures engine.

In one embodiment, the method may also include automatically generating the plurality of distribution agnostic measurements from one or more sensors in a manufacturing unit.

According to an embodiment of the disclosure, a non-transitory computer-readable storage medium is disclosed. The non-transitory computer-readable storage medium includes instructions that when executed by a computer, cause the computer to read, a dataset representative of a plurality of distribution agnostic measurements, the dataset including a plurality of observations. Each observation includes a response variable value and a plurality of explanatory variable values. The instructions cause the computer to fit, a regression solver to the dataset describe (or express) the response variable values as a function of the explanatory variables, a so-called regression equation; compute, a sample coefficient of multiple determination based on the function; compute, a kurtosis of a sample of fitted values; and output, a one- or two-sided confidence interval for the population coefficient of multiple.

According to an embodiment, a computer system is disclosed that includes a processor. The computer system also includes a memory storing instructions that, when executed by the processor, configure the computer system to read, a dataset representative of a plurality of distribution agnostic measurements, the dataset includes a plurality of observations, where each observation includes a response variable value and a plurality of explanatory variable values. The instructions further cause the computer system to fit a regression solver to the dataset to describe (or express) the response variable values as a function of the explanatory variables, a so-called regression equation; compute a sample coefficient of multiple determination based on the function; compute a kurtosis of a sample of fitted values; and output, a one- or two-sided confidence interval for the population coefficient of multiple determination.

### BRIEF DESCRIPTION OF THE DRAWINGS

To easily identify the discussion of any particular element or act, the most significant digit or digits in a reference number refer to the figure number in which that element is first introduced. The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts a block diagram of a network of data processing systems in which illustrative embodiments may be implemented.

FIG. 2 depicts a block diagram of a data processing system in which illustrative embodiments may be implemented.

FIG. 3 depicts a block diagram of an application in which illustrative embodiments may be implemented.

FIG. 4 depicts a process in which illustrative embodiments may be implemented.

FIG. 5 depicts a plot illustrative of an embodiment of the disclosure.

FIG. 6 depicts a plot illustrative of an embodiment of the disclosure.

FIG. 7 depicts a process in which illustrative embodiments may be implemented.

FIG. 8 depicts a process in which illustrative embodiments may be implemented.

FIG. 9 depicts a plot illustrative of an embodiment of the disclosure.

FIG. 10 depicts a plot illustrative of an embodiment of the disclosure.

FIG. 11 depicts a plot illustrative of an embodiment of the disclosure.

FIG. 12 depicts a plot illustrative of an embodiment of the disclosure.

FIG. 13 depicts a plot illustrative of an embodiment of the disclosure.

FIG. 14 depicts a plot illustrative of an embodiment of the disclosure.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The illustrative embodiments are related to manufacturing and other processes involving measurement of sensor data and data related to physical quantities and attributes of real-world objects. The illustrative embodiments comprise significantly improved confidence intervals computations and recognize that existing confidence interval (CI) methods for a population coefficient of multiple determination in the classical regression models may work when the regressor data come from a multivariate normal distribution. Applying these conventional methods to data from alternative non-normal multivariate distributions, however, may have disastrous consequences on the achieved coverage probabilities of the CIs. These normal theory CI methods can be sensitive to even minor deviations of the normality assumptions and their performance can deteriorate with increasing sample size. This is unsettling because the populations from which the samples are drawn are usually unknown.

The illustrative embodiments disclose robust CI procedures that are appropriate for normal measurements as well as non-normal measurements. In one aspect, a method is disclosed. The method provides a powerful process for computing a one- or two-sided confidence interval for a population coefficient of multiple determination in a fabrication environment.

The method comprises reading, by a computing device, a dataset representative of a plurality of distribution agnostic measurements. The dataset may comprise a plurality of observations, where each observation comprises a response variable value and a plurality of explanatory variable values. The method can fit by the computing device, a regression solver to the dataset to describe (or express) the response variable values as a function of a plurality of explanatory variable values and can compute, by the computing device, a sample coefficient of multiple determination based on the function. The method can further compute, by the computing device, a kurtosis of a sample of fitted values, and output a one- or two-sided confidence interval for the population coefficient of determination.

The method is beneficial over conventional methods in its estimation richness and veracity, especially for its analyses of distribution agnostic measurements in manufacturing processes. The assumption of multivariate normality for the explanatory variables is a major concern in the application of the conventional CI procedures, as applying these procedures when design matrix rows are drawn from an alternative multivariate distribution may yield serious over- or under-coverage depending upon the distribution. These procedures are certain to fail when applied to non-normal data because they are based upon the sampling distribution for the coefficient of multiple determination, R²; and the distribution of R² is inherently dependent upon the distribution of a sample variance which is renowned for being hypersensitive to nonnormality. Some major difficulties of the best conventional methods for computing CIs for ρ² besides being sensitive to the assumption of normality of the regressors under which they are derived are implementation and computation cost. They are more tedious to implement because they require numerical routines to solve nonlinear equations. Computing the confidence limits require solving two (independent) nonlinear equations, one for each confidence limit. Attempts to determine the confidence limits for many samples (for example, in simulation studies) may require considerable computation times. For example, applying the normal approximation CI method to 1000 samples is about 5 times faster than applying the Helland's F approximation method to the same samples.

The processes as disclosed herein include features to achieve significantly faster results by normal approximations that yield closed-form confidence limits and thereby improved computer functionality especially for significantly large data distributed over a plurality of nodes. Confidence interval procedures discussed herein is a powerful methodology for assessing the validity (not cross-validity) of classical regression equations.

More specifically, a population coefficient of multiple determination, ρ², may be interpreted as the proportion of variation in the response distribution explained by a model. Therefore, it can be used as a measure of goodness-of-fit. Based on a training sample, a known point estimator of ρ² is the sample coefficient of multiple determination denoted by R². The values of R² are confined in the interval [0,1]. Larger values near 1 are usually desired. R² is routinely provided as part of regression summary statistics. However, confidence intervals for ρ² are not known to be conventionally provided, particularly since regressor data are usually required to be normally distributed. A powerful advantage of CIs, nevertheless, is that they provide information about both accuracy and precision of point estimates such as R². In other words, a CI for ρ² relates information about the accuracy and the precision associated with the quality of fit estimates. The accuracy is measured by the confidence level or coverage probability of the CI. Common values of confidence levels are 99%, 95%, or 90%. For example, a 95% CI for ρ² can mean that a manufacturer is 95 percent confident that the CI contains the true parameter ρ². In other words, if the experiment that produced the CI is repeated many times, then about 95 percent of the resulting CIs will contain the true parameter ρ². The manufacturer may control the accuracy level by specifying the confidence level. The precision, however, is usually controlled by the size of the sample and is assessed by the width of the CI or equivalently the margin of error for the point estimate. For example, a small sample design may achieve a point estimate of R² near 1.0 suggesting an excellent fit of the model. This point estimate by itself may not give any information about the margin of error. If a CI is calculated, however, its width will reveal that the sample is too small so that the point estimate is not reliable.

In other applications where manufacturers are more interested in hypothesis testing, a confidence interval can also be used to test whether an effect is significant. For example, in the context of CI for ρ², an investigator may be interested in whether the true coefficient of multiple determination, ρ², is significantly different from 0.5. If the CI contains 0.5 then the manufacturer may conclude that the data does not provide enough evidence against the hypothesis that ρ² equals 0.5. On the other hand, if the CI does not contain 0.5 then there is statistical evidence that ρ² is significantly different 0.5.

An embodiment can be implemented as a software and/or hardware application. The application implementing an embodiment can be configured as a modification of an existing system, as a separate application that operates in conjunction with an existing system, a standalone application, or some combination thereof.

This manner of CI procedures is unavailable in the presently available methods in the technological field of endeavor pertaining to manufacturing statistics and predictive analytics. A method of an embodiment described herein, when implemented to execute on a device or data processing system, comprises substantial advancement of the computational functionality of that device or data processing system in configuring the performance of a predictive analytic platform.

The illustrative embodiments are described with respect to certain types of machines developing statistical and predictive analytic models based on data records obtained from sensor measurements or data. The illustrative embodiments are also described with respect to other scenes, subjects, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

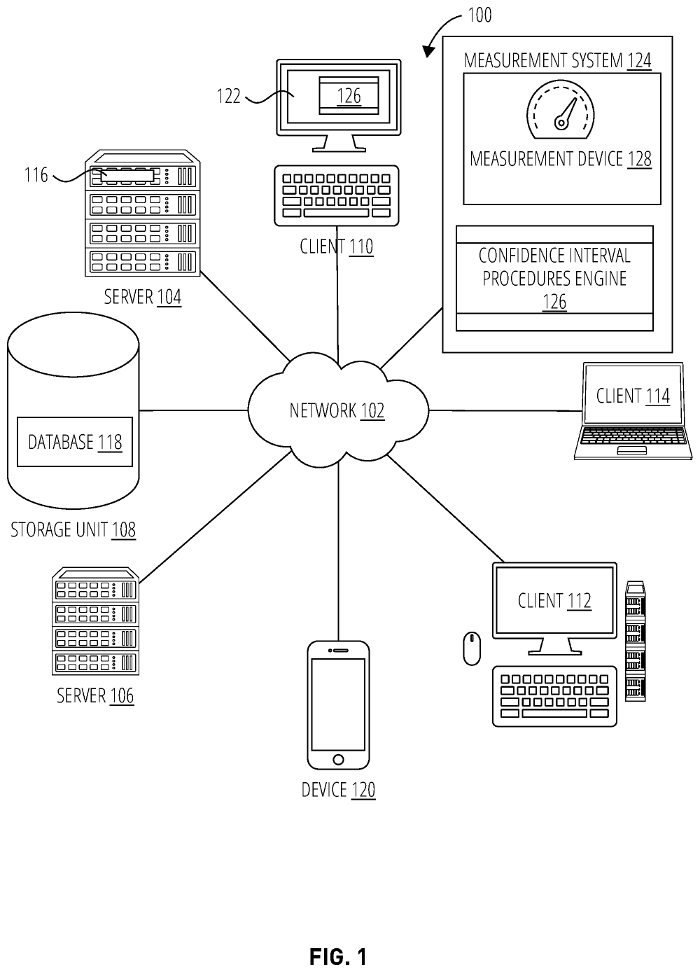

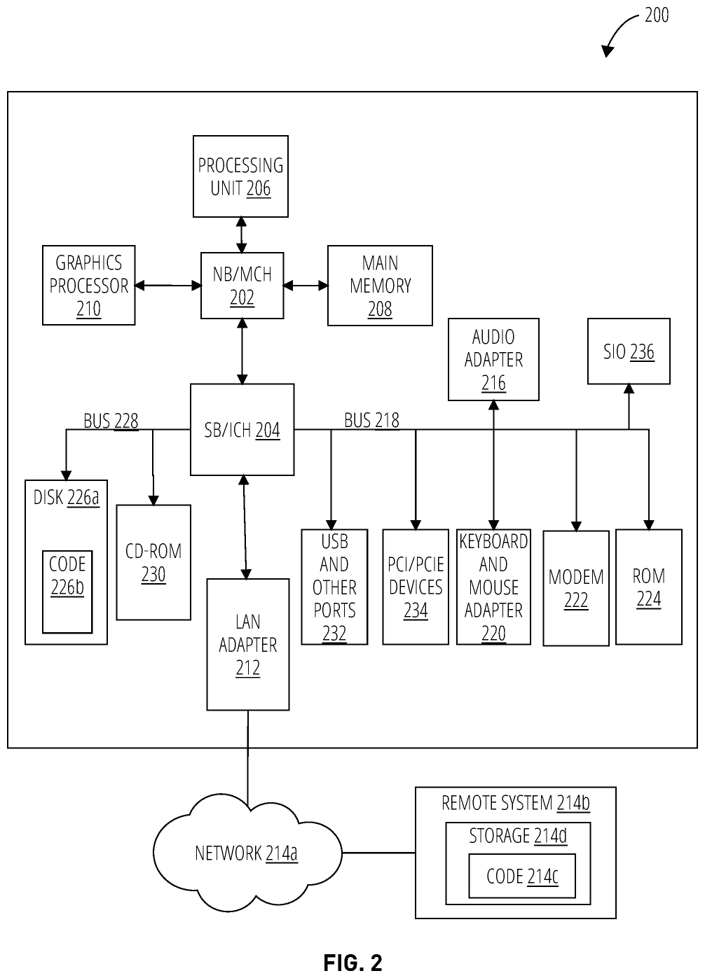

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of special purpose computers or fabrication platforms in which the illustrative embodiments may be implemented. Data processing environment 100 includes network 102. Network 102 is the medium used to provide communications links between various devices and special purpose computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as server 104 or server 106, or clients (client 110, client 112, client 114) may contain data and may have software applications or software tools executing thereon. Server 104 may include one or more GPUs (graphics processing units) for training one or more models.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Device 120 is an example of a device described herein. For example, device 120 can take the form of a smartphone, a special purpose fabrication platform, a tablet computer, a laptop computer, client 110 in a stationary or a portable form, a wearable computing device, or any other suitable device. Any software application described as executing in another data processing system in FIG. 1 can be configured to execute in device 120 in a similar manner. Any data or information stored or produced in another data processing system in FIG. 1 can be configured to be stored or produced in device 120 in a similar manner.

Confidence interval procedures engine 126 may execute as part of client application 122, server application 116 or on any data processing system herein. Confidence interval procedures engine 126 may also execute as a cloud service communicatively coupled to system services, hardware resources, or software elements described herein. Database 118 of storage unit 108 stores one or more measurements or data in repositories for computations herein.

Server application 116 implements an embodiment described herein. Server application 116 can use data from storage unit 108 for CI processes and testing. Server application 116 can also obtain data from any client for computations. Server application 116 can also execute in any of data processing systems (server 104 or server 106, client 110, client 112, client 114), such as client application 122 in client 110 and need not execute in the same system as server 104.

Server 104, server 106, storage unit 108, client 110, client 112, client 114, device 120 may couple to network 102 using wired connections, wireless communication protocols, or other suitable data connectivity. Client 110, client 112 and client 114 may be, for example, personal computers or network computers.

In the depicted example, server 104 may provide data, such as boot files, operating system images, and applications to client 110, client 112, and client 114. Client 110, client 112 and client 114 may be clients to server 104 in this example. Client 110, client 112 and client 114 or some combination thereof, may include their own data, boot files, operating system images, and applications. Data processing environment 100 may include additional servers, clients, and other devices that are not shown. Server 104 includes a server application 116 that may be configured to implement one or more of the functions described herein in accordance with one or more embodiments.

Server 106 may include a search engine configured to search measurements or sensor data or databases in response to a query with respect to various embodiments. In an implementation, measurements may be automatically generated and provided for confidence interval analysis procedures. The data processing environment 100 may also include a dedicated measurement system 124 which comprises the confidence interval procedures engine 126. The dedicated measurement system 124 may be used for performing measurements of defined properties, via special purpose measurement devices 128 such as strength measuring devices, medical devices, vision and imaging devices, detectors, transducers, sensors and instruments used in measuring physical quantities and attributes of real-world objects and events. The dedicated measurement system 124 may also be used to analyze samples using the confidence interval procedures engine 126. The confidence interval procedures engine 126 may make decisions about the reliability of fabrication processes by performing CI processes described herein based on obtained measurement data.

An operator of the measurement system 124 can include individuals, computer applications, and electronic devices. The operators may employ the confidence interval procedures engine 126 of the measurement system 124 to make predictions or decisions. An operator may desire that the confidence interval procedures engine 126 perform methods to satisfy a predetermined evaluation criterion.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as server 104, server 106, or client 110, client 112, client 114, measurement system 124 in FIG. 1, or another type of device in which computer usable program code or instructions implementing the processes may be located for the illustrative embodiments.

Data processing system 200 is also representative of a data processing system or a configuration therein, such as device 120 in FIG. 1 in which computer usable program code or instructions implementing the processes of the illustrative embodiments may be located. Data processing system 200 is described as a computer only as an example, without being limited thereto. Implementations in the form of other devices, such as device 120 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro- SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as server application 116 and client application 122 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

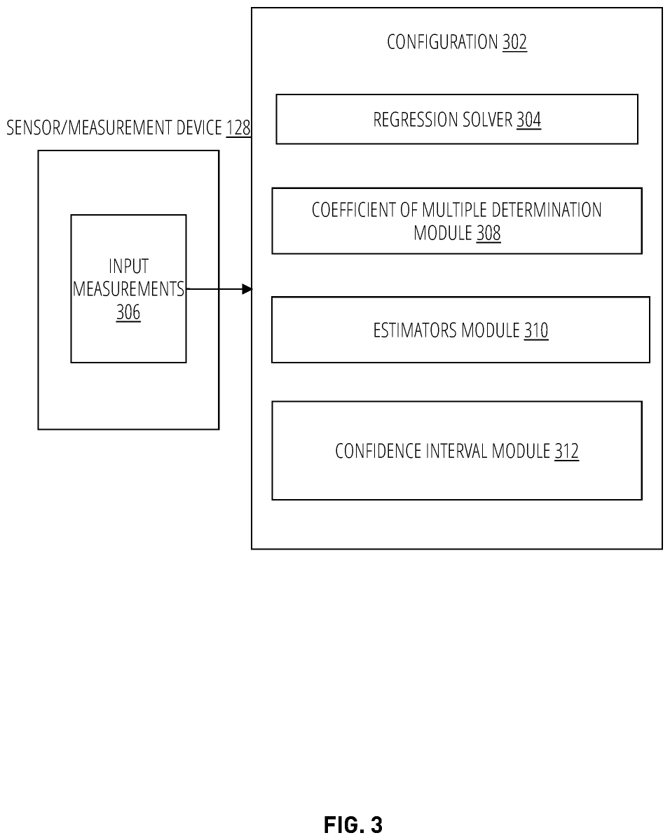

With reference to FIG. 3, this figure depicts a block diagram of an example configuration for manufacturing based on confidence intervals for a population coefficient of multiple determination. In a particular embodiment, configuration 302 is an example of confidence interval procedures engine 126, or a configuration including client application 122 or server application 116 of FIG. 1.

Configuration 302 may receive a plurality of input measurements 306 from a sensor or measurement device 128. In a particular embodiment, the input measurements 306 represents quantitative measurements obtained by an operator using one or more sensors and may be generated and or received automatically in a seamless/automated flow. For example, In the mass production of a product, manufacturers' objective may be to minimize variations so that a high proportion of their product meet satisfactory quality. During and after production, quality inspectors and design engineers may regularly engage specialized sensors to test product specimen to detect excessive variations in specific quality characteristics of a product. For example, a quality inspector of a steel plant may evaluate, based on a tolerance interval, that a certain high proportion (say, 99%) of the produced steels have strengths within some pre-specified limits defining the boundaries of satisfactory quality. To produce steels with the recommended strength, manufactures may rely on the linear relationship between steel strength and some predictor variables related to the raw materials. In another example, a chemist in a chemical plant may use a linear calibration to relate peek area and concentration of a key chemical component to ensure that a certain chemical product is produced with acceptable quality. In some cases, these may be automated. The validity of such a linear relationship may determine whether a high proportion of the goods will be produced with satisfactory quality. A measure of the validity of the relationship is the population true coefficient of multiple determination, ρ², which may be unknown and may be estimated. ρ² may also be interpreted as the true strength of the linear relationship between the response variable (output measurement) and the predictors (input measurements). Referring to the manufacturer of steels example, a random sample of steel strength measurements and (relevant) predictor measurements can be used to estimate ρ². Such an estimate called the sample coefficient of multiple determination, R², may be obtained when the steel strength is regressed on the relevant predictors. Typically, values of R² close to 1 may indicate that the degree of linear relationship between steel strength and the predictors is strong. Since a sample is used to compute R², however, there may be a margin of error associated with the point estimate. R² may be close to 1 but with a large margin of error. Thus, R², by itself, without a margin of error may provide insufficient information to validate the relationship between the steel strength and the relevant predictors. A confidence interval for ρ², on the other hand, provides information about the magnitude of ρ² and the related margin of error. From experience, the manufacturer may know that when a 95 percent lower limit for the population true coefficient of multiple determination, ρ², exceeds some predefined threshold value then a high proportion of the steels produced is more likely to meet the prespecified strength requirements set by the quality inspector. If a 95 percent confidence lower bound for ρ² is calculated assuming that the predictors are normally distributed when, in fact, they are not then the resulting lower confidence bound may be higher or lower than it should be. If it is higher, for example, then the lower confidence may exceed the prespecified threshold value giving the wrong impression that the ensuing produced steels will meet the strength requirements. If the quality inspector has a robust inspection system, then such errors may be detected at a later stage of the manufacturing process, but with a great cost to the manufacturer. If such defective products are shipped to customers undetected, however, then consumers may suffer the consequences. These difficulties could be avoided in the first place if the 95 percent confidence lower bound for ρ² was obtained using the robust confidence interval methods computed based on special purpose configurations and computers described herein in a manufacturing unit because it provides accurate, faster results for not only normal distributions but also for nonnormal distributions.

In the configuration 302, the configuration 302 may read, by a computing device of the configuration, the input measurements 306 as a plurality of distribution agnostic measurements, the dataset comprising a plurality of observations, wherein each observation comprises a response variable value and a plurality of explanatory variable value. The configuration 302 may fit a regression solver to the dataset to express the response variable values as a function of the explanatory variables. The configuration 302 may then compute, by the computing device, a sample coefficient of multiple determination based on the function. Estimator module 310 may perform various estimations/approximations as described hereinafter to provide a basis for computing one- or two-sided confidence interval by confidence interval module 312.

Regression Model with Random Explanatory Variables

A classical multiple regression model, referred to herein as the X-fixed regression model, may be expressed as y=β₀1ₙ+Xβ+e where the response is y=(y₁, . . . , yₙ)^{T}, 1ₙ is an n-component vector given by 1ₙ =(1, . . . , 1)^{T}, X is a fixed n×p design matrix, β₀ and β=(β₁, . . . , βₚ)^{T} are the unknown parameters, and and e=(e₁, . . . , eₙ)^{T} is a vector of independent normal random noises with mean E(eᵢ)=0 and variance Var(eᵢ)=2. In other words, the distribution of the vector y is a multivariate normal with mean β₀1ₙ+Xβ and variance-covariance matrix σ²Iₙ, where Iₙ is the n×n identity matrix.

The least squares estimates of the coefficient parameters may be given by \hat{β}=(X_{c}^{T}X_{c})⁻¹X_{c}^{T}y, \hat{β}₀=y̅−x̅β where y̅ is the sample mean of the response vector,

x̅ is a 1×p vector made of the sample means based on the design matrix X, and X_{c} is the n×p matrix whose columns are the centered columns of the design matrix. The matrix

[symbol]

X_{c} may written as X_{c}=X−1ₙx̅. The vector of fitted values, denoted by ŷ, is given by ŷ=(ŷ₁, . . . , ŷₙ)^{T}=\hat{β}₀1ₙ+X\hat{β}. We denote the error sum of squares, the regression sum of squares, and the total sum of squares by

$$SSE = {( y - \hat{y} )}^{T} ( y - \hat{y} ) = {\sum }_{i = 1}^{n} {( {y}_{i} - {\hat{y}}_{i} )}^{2} \\ SSR = {( \hat{y} - \overline{y} {1}_{n} )}^{T} ( \hat{y} - \overline{y} {1}_{n} ) = {\sum }_{i = 1}^{n} {( {\hat{y}}_{i} - \overline{y} )}^{2} \\ SST = {( y - \overline{y} {1}_{n} )}^{T} ( y - \overline{y} {1}_{n} ) = {\sum }_{i = 1}^{n} {( {y}_{i} - \overline{y} )}^{2}$$

The usual (sample) coefficient of multiple determination is given by

$${R}^{2} = 1 - \frac{SSE}{SST} = \frac{SSR}{SST} = \frac{( n - 1 ) {\hat{β}}^{T} {S}_{x} \hat{β}}{( n - p - 1 ) {\hat{σ}}^{2} + ( n - 1 ) {\hat{β}}^{T} {S}_{x} \hat{β}}$$

where \hat{σ}²SSE/(n−p−1) is an unbiased estimator of σ² and Sₓ=X_{c}^{T}X_{c}/(n−1) is a p×p symmetric matrix.

In some applications, e.g., design of manufacturing experiments, the values of the regressors may be controlled and fixed so that the experiment can be replicated. The X-fixed model is appropriate in these applications. In many other applications, however, e.g., observational studies, the values of the regressors are random and cannot be controlled. In these applications, a regression model which considers the random nature of the regressors may be adopted, said models being referred to herein as X-random models.

The regression model with random explanatory variables may be expressed the same way as the X-fixed model. In the X-random model, however, it may be assumed that the rows of the design matrix, xᵢ, . . . , xₙ, represent a random sample from a P-dimensional multivariate distribution with mean vector μₓ and variance-covariance matrix Σₓ. In addition, the rows of the design matrix may be assumed to be independent of the vector of random noises e.

For these models, the population coefficient of multiple determination may be defined as the maximum correlation between yᵢ and the linear combination xᵢ^{T}β. The corresponding maximum squared correlation is obtained as

$${ρ}^{2} = \frac{{[ Cov ( {y}_{i} , {x}_{i}^{T} β ) ]}^{2}}{Var ( {y}_{i} ) Var ( {x}_{i}^{T} β )} = \frac{Var ( {x}_{i}^{T} β )}{Var ( {y}_{i} )} = \frac{{β}^{T} {Σ}_{x} β}{{σ}^{2} + {β}^{T} {Σ}_{x} β} .$$

Similarly, the sample multiple correlation between yᵢ and the linear combination xᵢ^{T}β is maximized for b=\hat{β} and the corresponding maximum square correlation is R². From the above expressions of R², it can be seen that R² is a consistent estimator of ρ² since \hat{σ}² and Sₓ are consistent estimators of σ² and Σₓ, respectively. As an estimator of ρ², however, R² has a positive bias that is non-negligible for small to moderate number of regressors. An alternative consistent estimator of ρ² is the adjusted coefficient of multiple determination, denoted by R². It can be expressed in terms of R² as

$${R}_{a}^{2} = 1 - \frac{n - 1}{n - p - 1} ( 1 - {R}^{2} ) .$$

Inference in the X-fixed model can be deemed conditional while the inference in X-random is considered unconditional. For example, confidence intervals calculated in the X-fixed and X-random model are considered conditional and unconditional confidence intervals, respectively. In general, if an X-random model is treated as an X-fixed model then the analysis may yield misleading results unless the sample size is sufficiently large.

Current CI methods for ρ², example, Helland's CI, (described in Helland, I. S., On the interpretation and use of R² in regression analysis, Biometrics 43, 61-69, 1987) are derived assuming that the rows of the design matrix, xᵢ, . . . , xₙ, represent a random sample drawn from a P-dimensional multivariate normal distribution with mean vector μₓ and variance-covariance matrix Σₓ. These methods, exact or approximate, are bound to fail when applied to non-normal measurement data because they are based on the distribution of R² or a function of it.

### A New Normal Approximation Method

Under the normal assumption, another CI method may be provided that provides closed-form confidence limits. Herein, the Wald method may be used to approximate the distribution of U (U=R²/(1−R²)) to that of a normal distribution with mean μ and variance τ² and then a log transformation may be applied to accelerate convergence to normality. More specifically, using conditional expectations and the fact that SSR and SSE are independent, the exact first moment of U≡R²/(1−R²) may be obtained as

$$μ ( θ ) = E ( U ) = E ( SSR ) E ( \frac{1}{SSE} ) = \frac{( n + 1 ) θ + p}{n - p - 3}$$

where θ=ρ²/(1−ρ²)

The second (central) moment or variance of R²/(1−R²) may be calculated as

$${τ}^{2} ( θ ) = Var ( U ) = E [ {( \frac{SSR}{SSE} )}^{2} ] - {μ ( θ )}^{2} .$$

Again, since SSR and SSE are independent,

$$E [ {( \frac{SSR}{SSE} )}^{2} ] = E ( {SSR}^{2} ) E ( \frac{1}{{SSE}^{2}} ) = \frac{{p}^{2} + 2 p + 2 ( n - 1 ) ( 2 + p ) θ + ( n - 1 ) ( n + 1 ) {θ}^{2}}{( n - p - 3 ) ( n - p - 5 )}$$

After some algebra, the variance U may be obtained as

$${τ}^{2} ( θ ) = Var ( U ) = 2 \frac{( n - 3 ) p + 2 ( n - 1 ) ( n - 3 ) θ + ( n - 1 ) \_ ( 2 n - p - 4 ) {θ}^{2}}{{( n - p - 3 )}^{2} ( n - p - 5 )}$$

By the Wald method,

$$\frac{{R}^{2}}{1 - {R}^{2}} \dot{∼} N ( μ ( θ ) , {σ}^{2} ( θ ) ) .$$

### Equivalently,

$$\frac{( n - 1 ) ( T - θ )}{( n - p - 3 ) σ ( θ )} \dot{∼} N ( 0 , 1 ) where T = \frac{( n - p - 3 ) U - p}{n - 1} .$$

By the Cramer delta theorem,

$$\frac{( n - 1 ) ( log T - log θ )}{( n - p - 3 ) τ ( θ ) / ( θ )} \dot{∼} N ( 0 , 1 ) .$$

If \hat{θ} is a consistent estimator of θ then by Slutsky's theorem

$$Z = \frac{( n - 1 ) ( log T - lof θ )}{( n - p - 3 ) τ ( \hat{θ} ) / \hat{θ}} \dot{∼} N ( 0 , 1 )$$

A consistent estimator for θ=ρ²/(1−ρ²) is U≡R²/(1−R²) because R² is a consistent estimator of ρ². An alternative consistent estimator that is unbiased for θ is T. Thus, we use both estimators in our simulation studies to examine the estimator that produces the better coverage probabilities. Using this new approach, an approximate 100(1−α) percent two-sided CI for ρ² is given as [ρ_{L}², ρ_{U}²] where ρ_{L}² and ρ_{U}² are obtained as

$${ρ}_{L}^{2} = 1 - \frac{1}{1 + T exp ( - {z}_{α / 2} \hat{η} )} , {ρ}_{U}^{2} = 1 - \frac{1}{1 + T exp ( - {z}_{α / 2} \hat{η} )}$$

In the above, Z_{α} is the α×100^{th} upper percentile point of the standard normal distribution. Also, the (approximate) estimated standard error of logT is \hat{η} such that

$${\hat{η}}^{2} = \frac{{( n - p - 3 )}^{2} {τ}^{2} ( \hat{θ} )}{{( n - 1 )}^{2} {\hat{θ}}^{2}} = 2 \frac{( n - 3 ) p + 2 ( n - 1 ) ( n - 3 ) \hat{θ} + ( n - 1 ) ( 2 n - p - 4 ) {\hat{θ}}^{2}}{{( n - 1 )}^{2} ( n - p - 5 ) {\hat{θ}}^{2}}$$

In the above, we may use \hat{θ}=U or \hat{θ}=T to calculate the confidence intervals. Note also that

$$\frac{{R}_{a}^{2}}{1 - {R}_{a}^{2}} = \frac{( n - 1 ) {R}^{2} - p}{( n - 1 ) ( 1 - {R}^{2} )} \approx \frac{( n - 3 ) {R}^{2} - p}{( n - 1 ) ( 1 - {R}^{2} )} = T .$$

Thus, Rₐ²/(1−Rₐ²) is unbiased estimator of θ in large samples. One could therefore use the ratio based on the adjusted coefficient of determination as the estimator for θ in place of T.

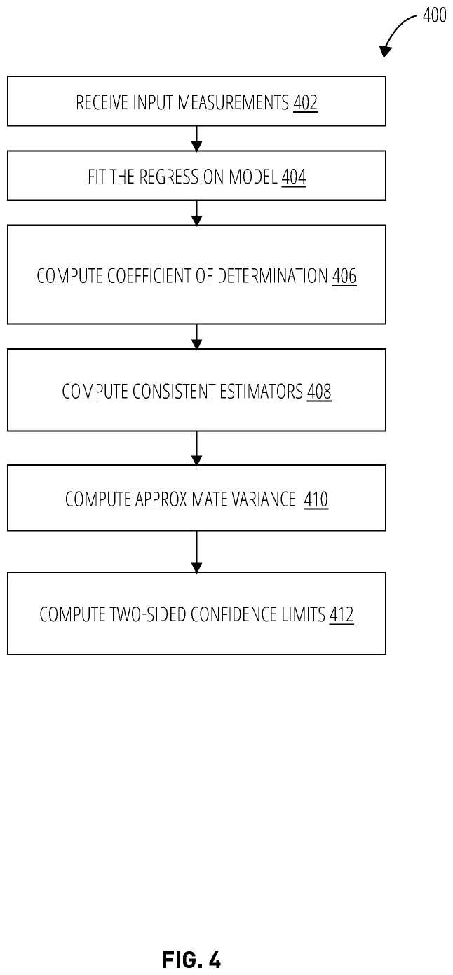

FIG. 4 illustrates the alternative simple normal approximation CI method 400 for ρ² with normal regressors. The example routine is configured for manufacturing based on confidence intervals for the population coefficient of multiple determination. Although the example routine depicts a particular sequence of operations, the sequence may be altered without departing from the scope of the present disclosure. For example, different components of an example device or system that implements the routine may perform functions at substantially the same time or in a specific sequence.

The method 400 may begin by receiving input manufacturing measurements at block 402. The input measurements (y, X) may comprise a plurality of observations in a manufacturing environment, wherein each observation comprises a response variable value and a plurality of explanatory variable values. Herein, y may be an n×1 vector and X may be an is n×p matrix.

The method 400 further comprises fitting, by the regression solver component 304 of the confidence interval procedures engine 126 a regression model at block 404, yᵢ=β₀+xᵢ^{T}β+σ²eᵢ, i=1, . . . , n where xᵢ is row i of the design matrix X, and eᵢ a standard normal random noise. The least squares estimate may be obtained \hat{β}₀ and \hat{β}=(\hat{β}₁, . . . , \hat{β}ₚ)^{T}.

The method 400 further comprises computing, by the confidence interval procedures engine 126, the coefficient of multiple determination at block 406,

$${R}^{2} = 1 - \frac{SSE}{SST} , where SSE = {\sum }_{i = 1}^{n} {( {y}_{i} - {\hat{y}}_{i} )}^{2} , SST = {\sum }_{i = 1}^{n} {( {y}_{i} - \overline{y} )}^{2} , {\hat{y}}_{i} = {\hat{β}}_{0} + {x}_{i}^{T} \hat{β} , \overline{y} = {\sum }_{i = 1}^{n} {y}_{i} / n .$$

In the method 400 the confidence interval procedures engine 126 may compute, at block 408 consistent estimators of

$$θ = {ρ}^{2} / ( 1 - {ρ}^{2} ) , U = \frac{{R}^{2}}{1 - {R}^{2}} and T = \frac{( n - p - 3 ) U - p}{n - 1} .$$

The method 400 further comprises computing at block 410 approximate variance of logT

$${\hat{η}}^{2} = 2 \frac{( n - 3 ) p + 2 ( n - 1 ) ( n - 3 ) \hat{θ} + ( n - 1 ) ( 2 n - p - 4 ) {\hat{θ}}^{2}}{{( n - 1 )}^{2} ( n - p - 5 ) {\hat{θ}}^{2}} ,$$

where \hat{θ}=U or \hat{θ}=T

At block 412, the confidence interval procedures engine 126 may compute two-sided confidence limits as

$${ρ}_{L}^{2} = 1 - \frac{1}{1 + T exp ( - {z}_{α / 2} \hat{η} )} and {p}_{U}^{2} = \frac{1}{1 + T exp ( - {z}_{α / 2} \hat{η} )}$$

and use it to assess the degree of linear relation between the response variable and the explanatory variables. Unlike conventional methods that require an iterative computationally costly root-finding routine, the method 400 gives closed-form expressions for the confidence limits.

The sensitivity of the normal theory CI methods is illustrated in two studies where the normal theory CI methods are applied to normal and non-normal measurement data. In a first study, the number of regressors was chosen to be small (p=5). 50,000 Monte Carlo p-dimensional multivariate samples of different sizes are simulated: 30, 50, 100, 150, 200, 250, 300, 350, 400, 450, and 500 from various theoretical multivariate distributions. The second study is identical to the first study except that the number of regressors is chosen to be moderate (p=50). In this case, however, the smallest sample size is 75 as opposed to 30. The non-normal multivariate distributions included in both studies have different statistical properties as follows.

The contaminated multivariate normal distribution. The contaminated multivariate normal distribution mimics real life situations where measurement data may be contaminated by outliers. For example, outliers may occur when measuring bacteria levels on various surfaces in a hospital room because the fast growth that happens once a small number of bacteria is present. This distribution is modelled by a two-component normal mixture density (1−q)φ(xᵢ; μₓ, Σₓ)+qφ(xᵢ; μₓ, kΣₓ) where φ(xᵢ; μₓ, Σₓ) is the density function of a p-dimensional multivariate normal distribution with mean vector μₓ and variance-covariance matrix Σₓ associated with row i of the design matrix; the parameter k is typically chosen to be large and the parameter 0<q<1 is small so that only a small proportion of the observations have a relatively large variance. In the studies, choices of k=10 and q-0.03 were made so that only 3 percent of the observations in each sample is contaminated. This distribution was chosen to assess the impact of outliers on the coverage probabilities of the CIs. The distribution is referred to as CNormal in the simulation studies.

The multivariate t distribution with 5 degrees distribution. This distribution represents a heavy-tailed alternative to the multivariate normal distribution. Despite the heavy tails its density function is almost undistinguishable from the multivariate normal distribution. We included this distribution to measure the impact of heavy tailed distribution on the coverage probabilities of the CIs. This distribution is referred to as T5 in the simulation studies.

The multivariate lognormal distribution. It is a skewed long-tailed distribution. On the log scale, observations drawn from this distribution have the normal distribution. The distribution was selected to evaluate the effect of skewness and long-tailed distributed measurement data on the coverage probabilities. The label “L Normal” is used as a reference to the lognormal population in the simulation studies.

For a given number of regressors, p, and sample size, n, the rows of the design matrix, x₁, . . . , xₙ, are drawn as a random sample from each of the above p-variate distribution (including the normal distribution) with mean vector μₓ and variance-covariance matrix Σₓ. The response observations are then obtained as yᵢ=β₀+xᵢ^{T}β+eᵢ, i=1, . . . n where eᵢ is an observation drawn from the univariate normal distribution with a constant variance σ². The true parameters values (β₀, β, σ² and Σₓ) in the model are chosen fixed such that the true population coefficient of determination

$${ρ}^{2} = \frac{{β}^{T} {Σ}_{x} β}{{σ}^{2} + {β}^{T} {Σ}_{x} β}$$

is moderate (ρ²=0.6, 0.65, 0.74).

For a given sample size, each of the 50,000 Monte Carlo generated multivariate samples are subjected to each of the CI methods: Helland's F approximation method (FA 510), the (new) normal approximation method used with the unbiased estimator of θ=ρ²/(1−ρ²) (NAUB 514) and used with the consistent but biased estimator of θ (NAB 512). For a given sample size, the simulated coverage probability is calculated as the proportion of the 50,000 samples that produce a two-sided 95% CI containing the true parameter ρ². As a result, for each sample size, the simulation standard error is \sqrt{0.95×0.05/50000}, which is about 0.097% points.

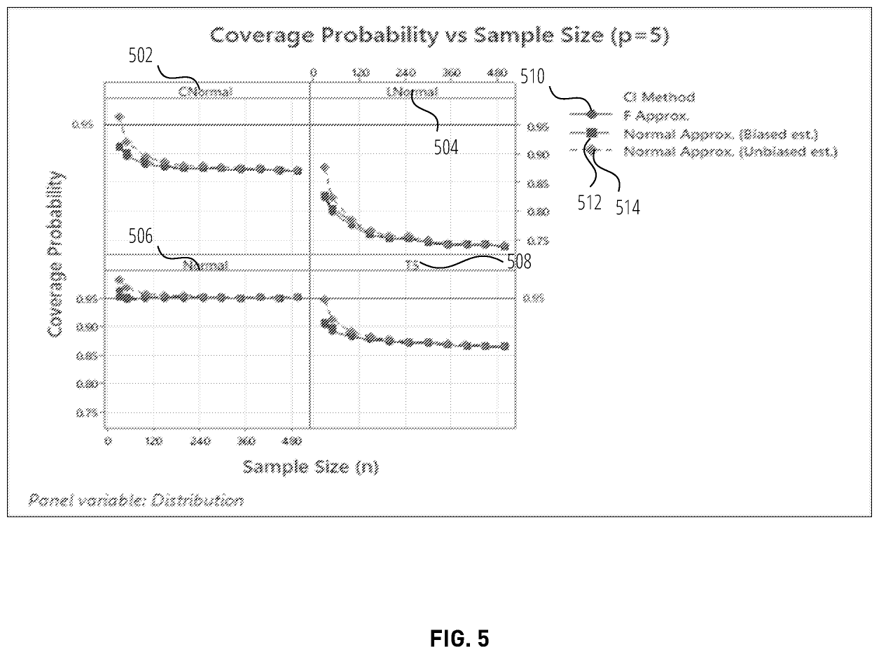

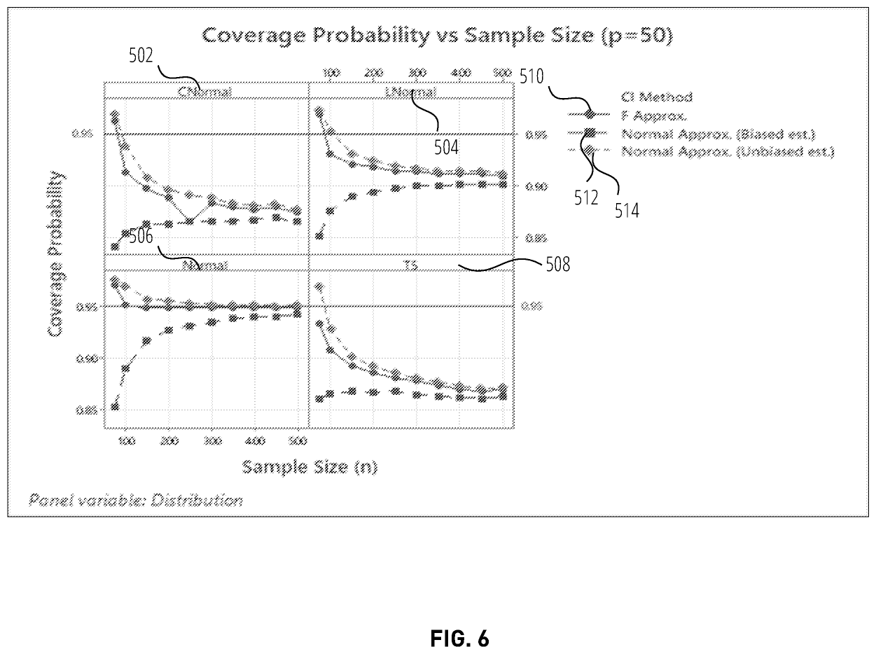

The graphs of FIG. 5-FIG. 6 illustrate the achieved coverage probabilities as a function of sample size for each CI method and each distribution. As shown in the graph of FIG. 5, the normal theory CI methods are applied to simulated data from 5-dimensional multivariate normal distribution (Normal 506) and multivariate nonnormal distributions. These include a contaminated multivariate normal distribution (CNormal 502), the multivariate t distribution with 5 degrees of freedom (T5 508), and a multivariate lognormal distribution (LNormal 504). The targeted nominal coverage probability is 0.95. The graph shows that the three CI methods work well when the data come from the normal distribution. When the data are generated from nonnormal distributions, however, they result serious under-coverage. The under coverage become worse with increasing sample size. For large samples, the achieved coverage probability is as low as 0.740 for the highly skewed lognormal, 0.877 for the contaminated normal, and 0.867 for the t distribution with 5 degrees of freedom.

The graph of FIG. 6 is identical to the one described under FIG. 5, except that the number of regressors was increased to p=50. The normal theory CI methods still work well for normal data. The normal approximation method that uses the biased estimator (NAB), however, achieved serious under-coverage for small to medium samples drawn from the normal distribution. This is because the bias of the estimator U=R²/(1−R²) is non negligible if n and P have about the same magnitude. The graph still depicts the devastating effects of applying the normal theory methods to non-normal data. For the contaminated normal distribution and the t distribution with 5 degrees of freedom the achieved coverage probabilities decrease to about the same low coverage as in the case where the number of regressors is 5. For the lognormal distribution, however, the decay in the achieved coverage probability is not as severe as before. In large samples, the achieved coverage stabilizes around 0.90.

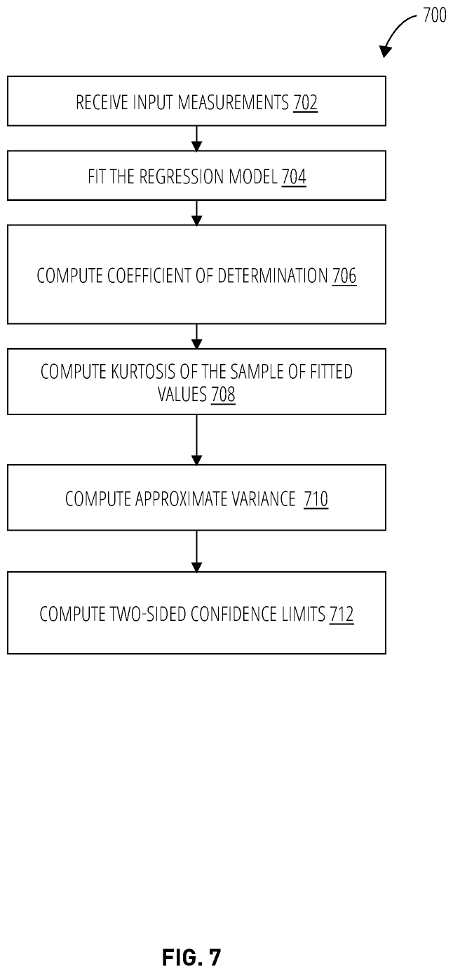

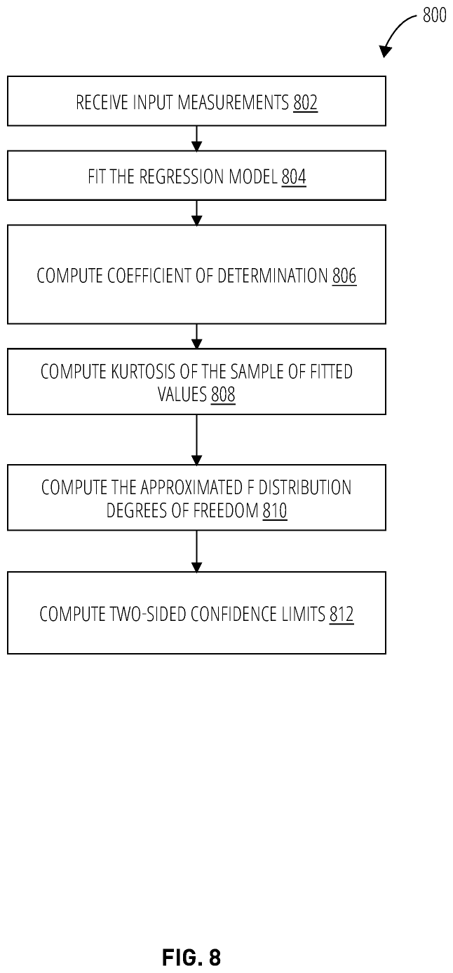

Turning now to FIG. 7 and FIG. 8, confidence interval methods will be described for non-normal regressors.

An approximation for the Distribution of SSR Under Nonnormality

Under the assumption that the rows of X being drawn from a multivariate normal distribution, the variate U can be written as

$$U ≡ \frac{{R}^{2}}{1 - {R}^{2}} = \frac{SSR}{SSE} ,$$

where SSR˜σ²χₚ²(λ) with λ˜θχₙ₋₁², θ=ρ²/(1−ρ²), and independently of SSR, SSE˜σ²χₙ₋ₚ₋₁². In addition, the distribution of U (or indirectly R²) depends on the assumed distribution of X only through the distribution of the non-centrality parameter λ given by

$$λ = θ \frac{( n - 1 ) {S}_{W}^{2}}{{β}^{T} {Σ}_{x} β} .$$

The variate S_{W}² is the sample variance of the random sample made of the univariate projections, wᵢ=xᵢ^{T}β, i=1, . . . n. Thus, if the rows of the design matrix, x₁, . . . , xₙ, represent a random sample from a p-dimensional multivariate normal distribution with mean vector μₓ and variance-covariance matrix Σₓ then S_{W}² is a sample variance based on a random sample, wᵢ=xᵢ^{T}β, i=1, . . . n, drawn from the normal population with mean μₓ^{T}β and variance β^{T}Σₓβ. As a result, λ˜θχₙ₋₁².

On the other hand, if the rows of the design matrix, x₁, . . . , xₙ, represent a random sample from some unspecified p-dimensional multivariate distribution with mean vector μₓ and variance-covariance matrix Σₓ, then S_{W}² is a sample variance based on a random sample, wᵢ=xᵢ^{T}β, i=1, . . . n, drawn from an unknown distribution with mean μₓ^{T}β and variance β^{T}Σₓβ. As a result, the distribution of λ is not necessarily the scaled chi-square distribution, θχₙ₋₁², unless the rows of the design matrix are randomly drawn from a multivariate normal distribution. Thus, if the rows of the design matrix are not necessarily drawn from a multivariate normal distribution, the distribution of the sample variance S_{w}² can be approximated, by matching its first two moments to those of a scaled chi-square distribution. The approximation may be limited to matching the first two moments because it is simple, and it yields great coverage probabilities even for skewed long tailed distributions such as the lognormal. The first two moments of the sample variance, S_{w}², based on the random sample drawn from the unknow population with mean μₓ^{T}β and variance β^{T}Σₓβ may be given by

$$E ( {S}_{w}^{2} ) = {σ}_{W}^{2} ≡ {β}^{T} {Σ}_{x} β , Var ( {S}_{W}^{2} ) = \frac{{σ}_{W}^{2}}{n} ( γ - \frac{n - 3}{n - 1} )$$

where γ is the kurtosis of the (unknown) distribution with mean μₓ^{T}β and variance σ_{W}²=β^{T}Σₓβ. By matching these moments to those of a scaled chi-square distribution it can be obtained that

$$\frac{( n - 1 ) {dS}_{W}^{2}}{{σ}_{W}^{2}} \dot{∼} {χ}_{( n - 1 ) d}^{2} where {σ}_{W}^{2} = {β}^{T} {Σ}_{x} β and d = \frac{2 n}{( n - 1 ) γ - ( n - 3 )} ,$$

It follows then that the approximate distribution SSR is σ²Xₚ²(λ), where

$$λ \dot{∼} \frac{{θχ}_{( n - 1 ) d}^{2}}{d} .$$

If the rows of the design matrix are known to have come from a multivariate normal distribution, then γ is the kurtosis of a univariate normal distribution which is 3. Consequently, d=1 and the distribution of SSR is exactly σ²χₚ²(λ), where λ˜θχₙ₋₁² as before. It can be concluded that if the regressors are not necessarily normally distributed then

$$U ≡ \frac{{R}^{2}}{1 - {R}^{2}} = \frac{SSR}{SSE} ,$$

where SSR\dot{˜}σ²χₚ²(λ) with

$$λ \dot{∼} \frac{{θχ}_{( n - 1 ) d}^{2}}{d} , θ = {ρ}^{2} / ( 1 - {ρ}^{2} ) ,$$

and independently of SSR, SSE˜σ²χₙ₋ₚ₋₁². This result provides the foundation for deriving CI methods for ρ² when the distribution of the regressors is not necessarily normal.

### Adjusted CI Method Using the F Approximation Approach

Helland's CI may be modified to be applicable to measurement data that are not necessarily normally distributed. This is referred to herein as the adjusted F approximation CI method. The distribution of the variate,

$${Y}_{1} = \frac{SSR}{{σ}^{2}} ,$$

may be approximated by a scaled chi-square distribution, aχ_{δ}², where a and δ are found by equating the first two moments of the two variates. More specifically, the first two cumulants of Y₁ are

$$E ( {Y}_{1} ) = E [ E ( {Y}_{1} \vert λ ) ] = E ( p + λ ) \approx p + ( n - 1 ) θ \\ Var [ {Y}_{1} ] = E [ Var ( {Y}_{1} \vert λ ) ] + Var [ E ( {Y}_{1} \vert λ ) ] \approx 2 [ p + 2 ( n - 1 ) θ + \frac{( n - 1 ) {θ}^{2}}{d} ]$$

Since first two cumulants of aχ_{δ}², are aδ and 2a²δ the solution for a and δ are

$$a = \frac{p + 2 ( n - 1 ) θ + ( n - 1 ) {θ}^{2} / d}{p + ( n - 1 ) θ} , δ = \frac{p + ( n - ) θ}{a} .$$

As a result, an approximate distribution of U may be expressed as

$$\frac{n - p - 1}{p + ( n - 1 ) θ} U \dot{∼} {F}_{{δ}_{d} , n - p - 1} where {δ}_{d} = \frac{{[ p + ( n - 1 ) θ ]}^{2}}{p + 2 ( n - 1 ) θ + {( n - 1 )}^{2} {θ}^{2} / d} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{d} - 1 ) {ρ}^{4}}$$

As pointed out earlier, if the rows of the design matrix form a random sample from a multivariate normal distribution, then d=1 and

$${δ}_{d} = {δ}_{1} = \frac{{[ ( n - p - 1 ) {ρ}^{2} + p ]}^{2}}{n - 1 - ( n - p - 1 ) {( 1 - {ρ}^{2} )}^{2}} = v .$$

(ν is the first degree of freedom associated with the F distribution in the Helland's method when normality is assumed.) On the other hand, if the rows of the design matrix represent a random sample drawn from some non-normal or unspecified multivariate distribution then d must be estimated. Let \hat{d} be a consistent estimator of d. Then by Slutsky's theorem,

$$\frac{n - p - 1}{p + ( n - 1 ) θ} \frac{{R}^{2}}{1 - {R}^{2}} \dot{∼} {F}_{{δ}_{\hat{d}} , n - p - 1} , where {δ}_{\hat{d}} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{\hat{d}} - 1 ) {ρ}^{4}} , \hat{d} = \frac{2 n}{( n - 1 ) \hat{γ} - ( n - 3 )}$$

and ŷ the sample kurtosis of the sample w₁, . . . , wₙ where wᵢ=xᵢ^{T}\hat{β}, i=1, . . . n. Since the sample kurtosis is invariant under linear transformation, ŷ is the kurtosis estimate for the sample of fitted values. It follows that an approximate 100(1−α) percent two-sided CI for ρ² is obtained as [ρ_{L}², ρ_{U}²] where ρ_{L}² and ρ_{U}² are the solutions of the nonlinear equations

$${ρ}^{2} = \frac{( n - p - ) {R}^{2} - ( 1 - {R}^{2} ) {pF}_{{δ}_{\hat{d}} , n - p - 1}^{α / 2}}{( n - p - 1 ) [ {R}^{2} + ( 1 - {R}^{2} ) {F}_{{δ}_{\hat{d}} , n - p - 1}^{α / 2} ]} ,$$

respectively.

### Adjusted CI Method Using the Normal Approximation Approach

Under the normal assumption, an approximate 100(1−α) percent two-sided CI for ρ² is given as [ρ_{L}², ρ_{U}²] where ρ_{L}² and ρ_{U}² are obtained as

$${ρ}_{L}^{2} = 1 - \frac{1}{1 + exp ( - {z}_{α / 2} \hat{η} )} , {ρ}_{U}^{2} = \frac{1}{1 + exp ( - {z}_{α / 2} \hat{η} )} where {\hat{η}}^{2} = 2 \frac{( n - 3 ) p + 2 ( n - 1 ) ( n - 3 ) \hat{θ} + ( n - 1 ) ( 2 n - p - 4 ) {\hat{θ}}^{2}}{{( n - 1 )}^{2} ( n - p - 5 ) {\hat{θ}}^{2}}$$

with \hat{θ}=U or \hat{θ}=T.

These intervals can be adjusted to be applicable to normal measurement data as well as non-normal measurement data. This method is referred to herein as the adjusted normal approximation method. The Wald method may be used to approximate the distribution of U by those of a normal distribution with mean μ and variance τ² and then apply a log transformation to accelerate convergence to normality. Since the data are not necessarily normally distributed, the SSR is approximately distributed σ²Xₚ²(λ), where

$$λ \dot{∼} \frac{{θχ}_{( n - 1 ) d}^{2}}{d} .$$

Proceeding as in the normal case,

$$U ≡ \frac{{R}^{2}}{1 - {R}^{2}} \dot{∼} N ( μ ( θ ) , {τ}^{2} ( d , θ ) ) , where μ ( θ ) \approx \frac{( n - 1 ) θ + p}{n - p - 3} , {τ}^{2} ( d , θ ) = Var ( U ) \approx 2 \frac{( n - 3 ) p + 2 ( n - 1 ) ( n - 3 ) θ + ( n - 1 ) ( n - 1 + \frac{n - p - 3}{d} ) {θ}^{2}}{{( n - p - 3 )}^{2} ( n - p - 5 )}$$

Equivalently,

$$\frac{( n - ) ( T - θ )}{( n - p - 3 ) τ ( d , θ )} \dot{∼} N ( 0 , 1 ) , where T = \frac{( n - p - 3 ) U - p}{n - 1} .$$

By the Cramer delta theorem,

$$\frac{( n - 1 ) ( log T - log θ )}{( n - p - 3 ) τ ( d , θ ) / θ} \dot{∼} N ( 0 , 1 )$$

If \hat{d} and \hat{θ} are consistent estimators of d and θ then by Slutsky's theorem

$$Z = \frac{( n - 1 ) ( log T - log θ )}{( n - p - 3 ) τ ( \hat{d} , \hat{θ} ) / \hat{θ}} \dot{∼} N ( 0 , 1 ) .$$

It follows then that an approximate 100(1−α) percent two-sided CI for ρ² based on the adjusted normal approximation method is given by [ρ_{L}², ρ_{U}²] where ρ_{L}² and ρ_{U}² are obtained as

$${ρ}_{L}^{2} = 1 - \frac{1}{1 + T exp ( - {z}_{α / 2} \hat{η} )} , {p}_{U}^{2} = \frac{1}{1 + T exp ( - {z}_{α / 2} \hat{η} )} where \\ {\hat{η}}^{2} ≡ \frac{( n - p - 3 ) τ ( \hat{d} , \hat{θ} )}{\hat{θ}} = 2 \frac{( n - 3 ) p + 2 ( n - 1 ) ( n - 3 ) \hat{θ} + ( n - 1 ) ( n - 1 + \frac{n - p - 3}{\hat{d}} ) {\hat{θ}}^{2}}{{( n - )}^{2} ( n - p - 5 ) {\hat{θ}}^{2}} \\ \hat{d} = \frac{2 n}{( n - 1 ) \hat{γ} - ( n - 3 )}$$

If the measurement data is known to be normally distributed, then γ=\hat{γ}=3 so that d=\hat{d}=1. As a result, these confidence intervals reduce to those given previously. The two newly derived CI methods for non-normal data rely on a consistent estimator of the unknown kurtosis, γ. More specifically, since the distribution of the rows of the design matrix is unknown the kurtosis γ may be estimated as the sample kurtosis of the fitted values: w₁, . . . , wₙ where wᵢ=xᵢ^{T}\hat{β}, i=1, . . . n. If ŷ is a consistent estimator of γ then

$$\hat{d} = \frac{2 n}{( n - 1 ) \hat{γ} - ( n - 3 )}$$

is also a consistent estimator of d as a continuous function of γ. A well-known consistent estimator of γ is the classical estimator given by

$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}}$$

The publication by Curto, (Curto, J. D. Confidence intervals for means and variances of non-normal distributions Communications in Statistics-Simulation and Computation, 2021), shows that replacing the mean w̅ with the sample median \tilde{w} in the numerator yields better estimates.

FIG. 7 illustrates the adjusted normal approximation CI Method for ρ² under nonnormality of regressors. Although the example routine depicts a particular sequence of operations, the sequence may be altered without departing from the scope of the present disclosure. For example, different components of an example device or system that implements the routine may perform functions at substantially the same time or in a specific sequence.

The method 700 may begin by receiving input manufacturing measurements at block 702. The method 400 further comprises fitting, by the regression solver component 304 of a confidence interval procedures engine 126 a regression model at block 704.

The method 700 further comprises computing, by the confidence interval procedures engine 126, the coefficient of determination at block 706. In the method 700 the confidence interval procedures engine 126 may compute, at block 708 kurtosis of the sample of fitted values: wᵢ=xᵢ^{T}\hat{β}, i=1, . . . n and

$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} or \hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}}$$

where w̅ and \tilde{w} are the sample mean and sample median, respectively.

The method 700 further comprises computing at block 710 the approximate variance of log T:

$${\hat{η}}^{2} = 2 \frac{( n - 3 ) p + 2 ( n - 1 ) ( n - 3 ) \hat{θ} + ( n - 1 ) ( n - 1 + ( n - p - 3 ) / \hat{d} ) {\hat{θ}}^{2}}{{( n - 1 )}^{2} ( n - p - 5 ) {\hat{θ}}^{2}} , where \hat{θ} = T = \frac{( n - p - 3 ) U - p}{n - 1} , and \hat{d} = 2 n / [ ( n - 1 ) \hat{γ} - ( n - 3 ) ] , U = \frac{{R}^{2}}{1 - {R}^{2}} .$$

T is an unbiased estimator of

$$θ = \frac{{ρ}^{2}}{1 - {ρ}^{2}} .$$

At block 712, the confidence interval procedures engine 126 may compute two-sided confidence limits as

$${ρ}_{L}^{2} = 1 - \frac{1}{1 + T exp ( - {z}_{α / 2} \hat{η} )} and {p}_{U}^{2} = \frac{1}{1 + T exp ( - {z}_{α / 2} \hat{η} )}$$

and use it to evaluate the model or assess the degree of linear relation between the response variable and the explanatory variables. Under normality the value of the kurtosis is known to be 3 so that the CI method 700 becomes the same as CI method 400.

Turning now to FIG. 8, another method 800 is illustrated. The method 800 depicts the adjusted F approximation CI Method for ρ² under nonnormality of regressors. However, the multivariate distribution of the regressors is unspecified. Like method 700, method 800 relies upon the kurtosis of the sample of fitted values. Although the example routine depicts a particular sequence of operations, the sequence may be altered without departing from the scope of the present disclosure. For example, different components of an example device or system that implements the routine may perform functions at substantially the same time or in a specific sequence.

The method 800 may begin by receiving input manufacturing measurements at block 802. The method 800 further comprises fitting, by the regression solver component 304 of a confidence interval procedures engine 126 a regression model at block 804.

The method 700 further comprises computing, by the confidence interval procedures engine 126, the coefficient of determination at block 806. In the method 800 the confidence interval procedures engine 126 may compute, at block 808 kurtosis of the sample of fitted values: wᵢ=Xᵢ^{T}\hat{β}, i=1, . . . n and

$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} or \hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}}$$

where w̅ and \tilde{w} are the sample mean and sample median, respectively.
The method 800 further comprises computing at block 810 the first degrees of freedom for the F distribution

$${δ}_{\hat{d}} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{\hat{d}} - 1 ) {ρ}^{4}} , \hat{d} = 2 n / [ ( n - 1 ) \hat{γ} - ( n - 3 ) ] .$$

At block 812, the confidence interval procedures engine 126 may compute two-sided confidence limits: ρ_{L}² and ρ_{U}² where ρ_{L}² is a solution of:

$${ρ}^{2} = \frac{( n - p - 1 ) {R}^{2} - ( 1 - {R}^{2} ) {pF}_{{δ}_{\hat{d}} , n - p - 1}^{α / 2}}{( n - p - 1 ) [ {R}^{2} - ( 1 - {R}^{2} ) {F}_{{δ}_{\hat{d}} , n - p - 1}^{α / 2} ]}$$

and ρ_{U}² is a solution of:

$${ρ}^{2} = \frac{( n - p - 1 ) {R}^{2} - ( 1 - {R}^{2} ) {pF}_{{δ}_{\hat{d}} , n - p - 1}^{α / 2}}{( n - p - 1 ) [ {R}^{2} - ( 1 - {R}^{2} ) {F}_{{δ}_{\hat{d}} , n - p - 1}^{α / 2} ]} .$$

Under normality the value of the kurtosis is known to be 3 so that these equations reduce to Helland's equations for finding the confidence limits when the regressor data come from a multivariate normal population.

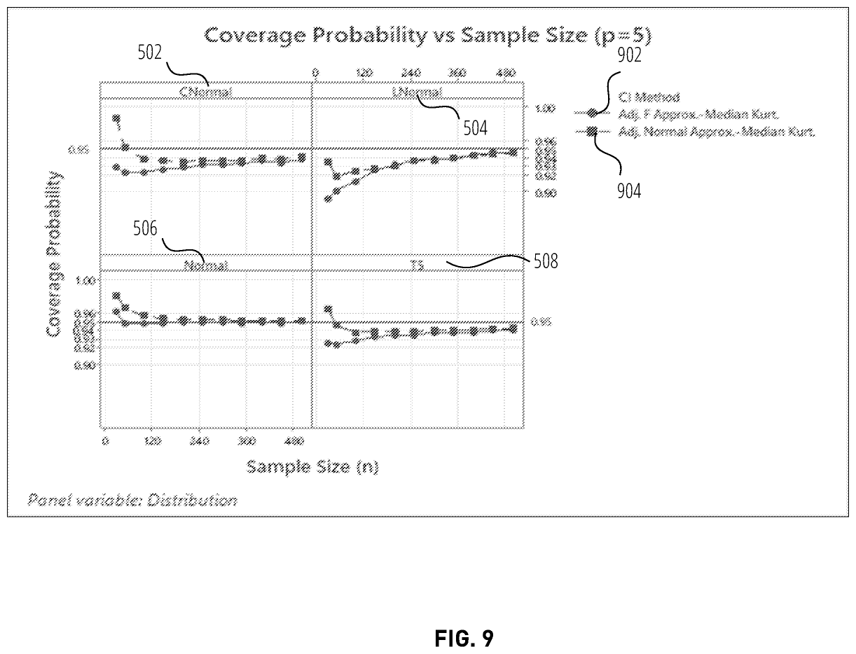

FIG. 9-FIG. 14, show that the disclosed CI methods are resistant against the normal assumption. The methods include the adjusted F approximation CI method 800 used with the classical kurtosis (“mean” kurtosis) estimate (AFACK) and used with Curto's kurtosis (“median” kurtosis) estimate (AFAMK 902); the adjusted normal approximation CI method 700 used with the “mean” kurtosis estimate (ANACK) and used with the “median” kurtosis estimate (ANAMK). It was seen that methods based on the “median” kurtosis yield the better coverage probabilities and interval widths and thus (AFAMK 902 and ANAMK 904) are depicted in the graphs. As seen in FIG. 9, the robust CI methods are applied to measurement data from a 5-dimensional multivariate normal distribution (Normal 506) and several multivariate non-normal distributions including a contaminated multivariate normal distribution (CNormal 502), the multivariate t distribution with 5 degrees of freedom (T5 508), and a multivariate lognormal distribution (LNormal 504). The targeted nominal coverage probability is 0.95. The graph shows that the two methods work well when the data come from the normal distribution. For non-normal measurement data, they yield coverage probabilities that are nearly close to the nominal level but from below (about 0.945, in large samples). The adjusted normal approximation CI method 700 tends to be conservative in small sample designs while the adjusted F approximation method 800 tends to be liberal for those designs. The adjusted normal approximation method has a slight advantage over the adjusted F approximation method in general.

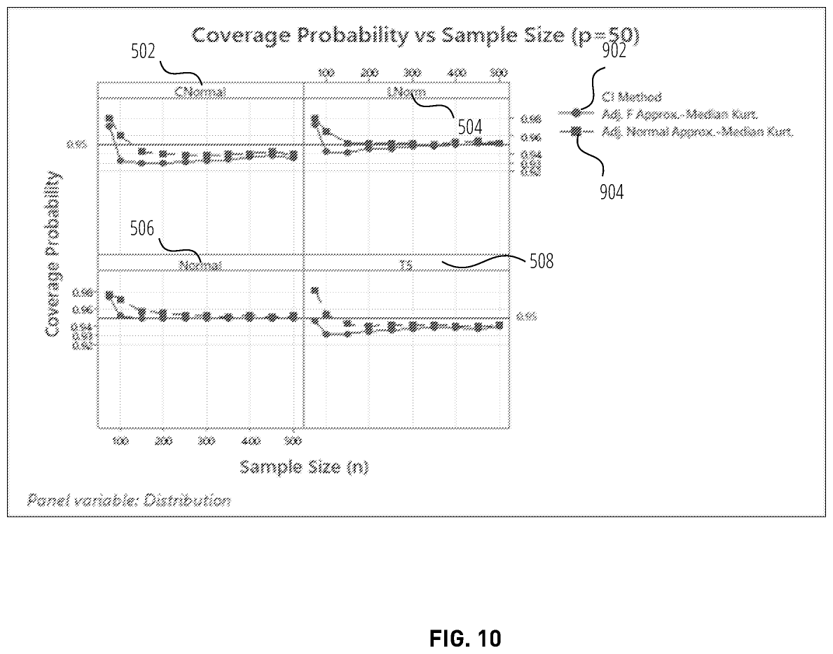

Turning to FIG. 10, the robust CI methods are applied to simulated data from 50-dimensional multivariate distributions as opposed to from 5-dimensional multivariate distributions. For the normal, the contaminated normal and the t distribution with 5 degrees of freedom distributions, there is a slight improvement in the achieved coverage probabilities compared to the case where the number of regressors is only 5. For the lognormal distribution, however, the improvement is exceptional.

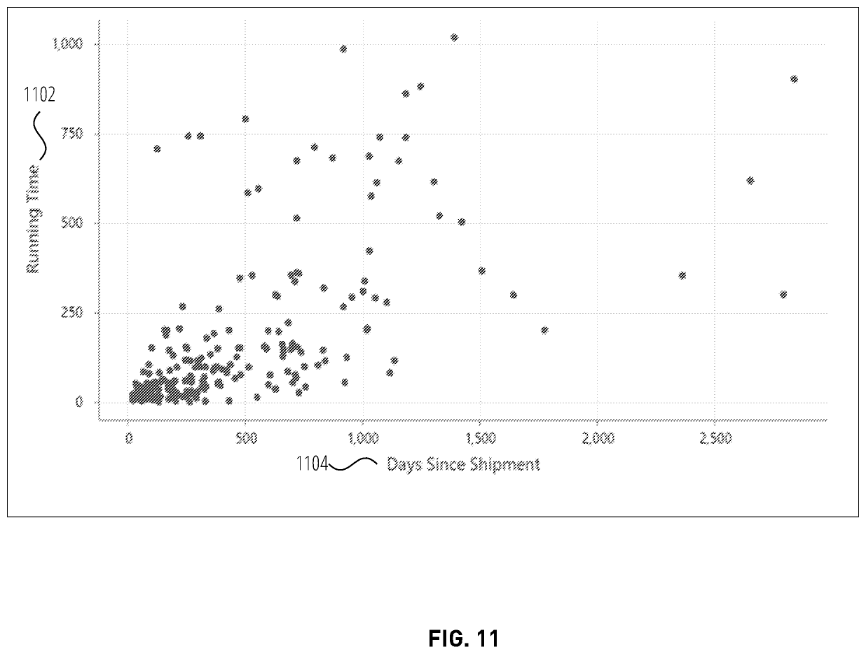

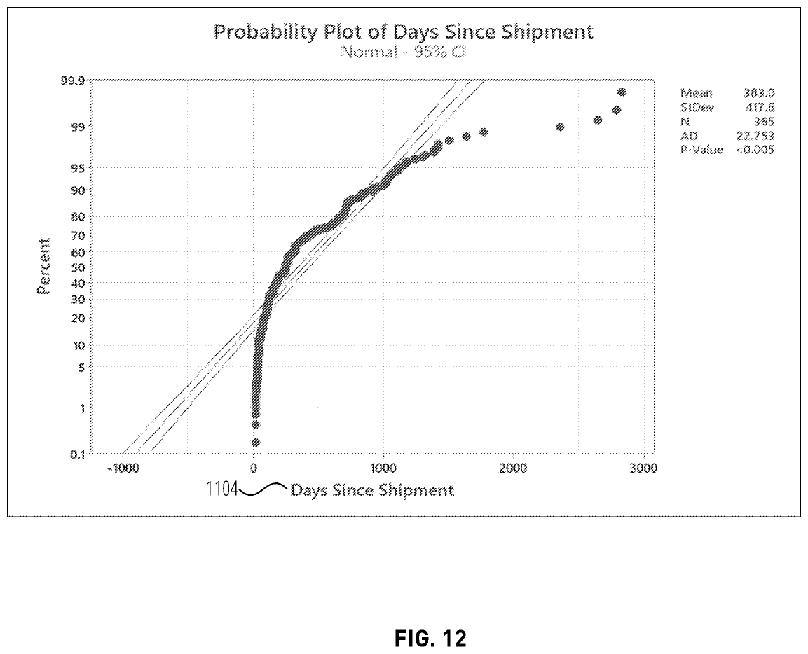

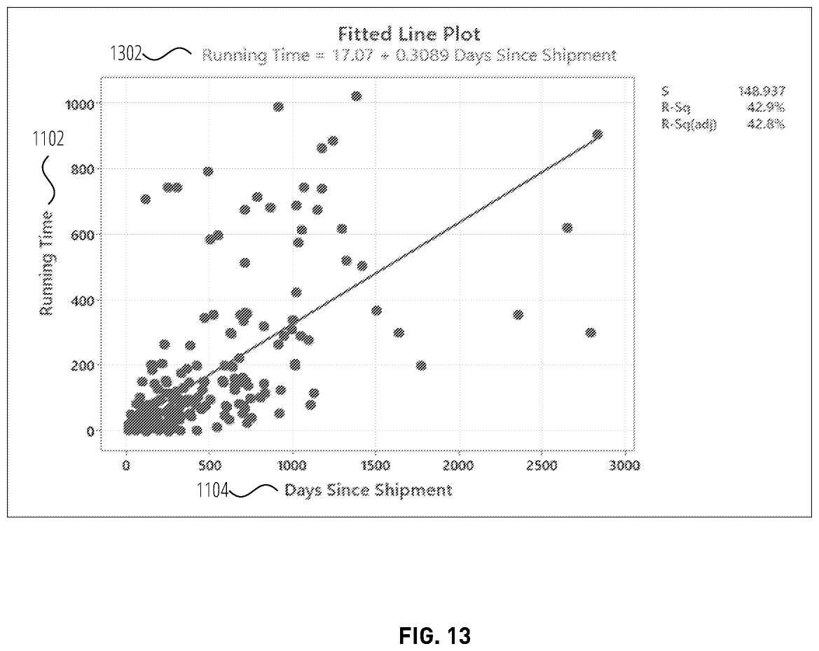

In an illustrative example using actual measurement data, an automobile manufacturer may generate, from a dedicated network of engine-running-time sensors information about a running time of a plurality of automobile engines. The manufacturer may perform an analysis of the relationship between the number of days from shipment until a warranty claim is reported and the running time on the engine. This may enable the manufacturer to obtain an estimate of upcoming warranties based on an estimate the running time on engines that have either failed or not yet failed based only on their shipment date. FIG. 11 shows a scatterplot, for a sample size of N=365, that displays the relationship between the running time 1102 on the engine and the number of days from shipment 1104 when the warranty claim was made. As the probability plot of FIG. 12 indicates, the p-value for the Anderson-Darling test for a normal distribution (P<0.005) may suggest that the number of days from shipment 1104 of the part do not come from a normally distributed population because the p-value is less than the threshold of α=0.05. The scatterplot with regression fit in FIG. 13 shows the relationship 1302 between the actual number of days since shipment of the engine and the actual running hours of the available engines. The R² value is 42.9 percent and the R² is 42.8 percent. The manufacturer, however, worry that there may considerable uncertainty about these points estimates of the population coefficient of determination (ρ²). As a result, the manufacturer may want to determine the minimum possible value of ρ² with a 95 percent confidence. By using existing normal theory methods, the results may be unreliable because the predictor variable, Days Since Shipment, deviates significantly from a normal distribution. Thus, the methods disclosed herein may be used to handle the non-normality in the predictor variable. Table. 1 shows the resulting lower confidence bounds from applying the normal and non-normal theory methods. For this data, with a 95 percent confidence, the minimum population coefficient of determination is about 33 percent as opposed to 36 percent obtained using the normal theory methods.

TABLE 1
Lower confidence bounds 1
n = 365, p = 1, R² = 42.938%, Rₐ² = 42.781%, \hat{γ} = 15.822

| 95% Lower Confidence Bound | | 95% Lower Confidence Bound | |
|---|---|---|---|
| (Assuming normality) | | (Without Assuming Normality) | |
| | Normal | Adjusted F | Adjusted Normal |
| F | Approximation | Approximation | Approximation |
| Approximation | (New) | (New) | (New) |
| 36.269% | 36.315% | 33.635% | 33.098% |

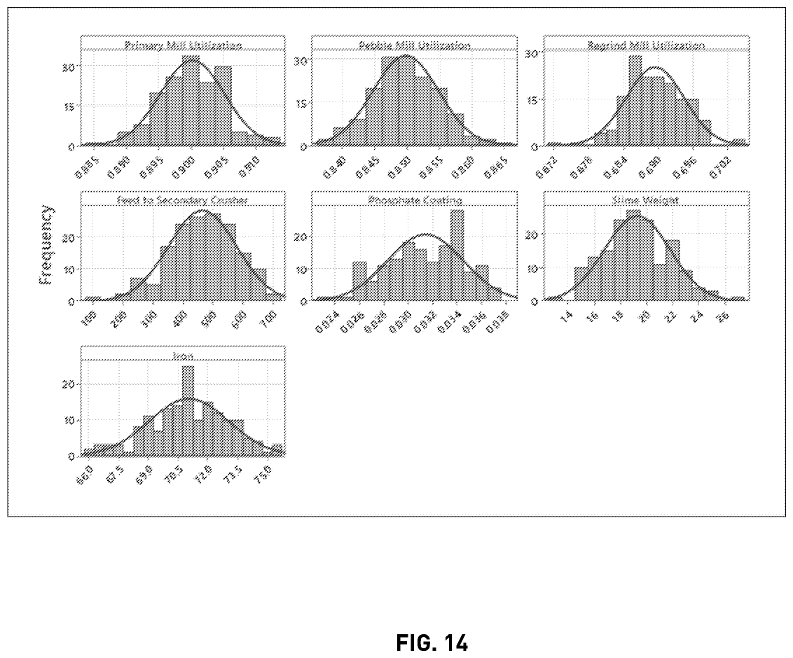

In another illustrative example using actual measurement data, a steel manufacturer may record data from various steps in a process to determine which process variables can accurately predict feed rate. For a sample size of N=160, the histograms of FIG. 14 show that the predictor variables do not deviate substantially from a multi-variate normal distribution.

As seen in the regression results in Table. 2 below, the R² value is 34.2 percent and the Rₐ² is 31.1 percent.

TABLE 2
Regression results.
Regression Equation
Feed Rate = 277 − 2448 Primary Mill Utilization + 1052 Pebble Mill
Utilization + 1634 Regrind Mill Utilization + 0.0291 Feed to Secondary
Crusher + 2672 Phosphate Coating − 1.500 Slime Weight + 1.347 Iron
Coefficients

| | | SE | T- | P- | |
|---|---|---|---|---|---|
| Term | Coef | Coef | Value | Value | VIF |
| Constant | 277 | 288 | 0.96 | 0.337 | |
| Primary Mill | −2448 | 565 | −4.33 | 0.000 | 4.28 |
| Utilization | | | | | |
| Pebble Mill | 1052 | 560 | 1.88 | 0.062 | 4.41 |
| Utilization | | | | | |
| Regrind Mill | 1634 | 289 | 5.65 | 0.000 | 1.17 |
| Utilization | | | | | |
| Feed to Secondary | 0.0291 | 0.0130 | 2.25 | 0.026 | 1.18 |
| Crusher | | | | | |
| Phosphate Coating | 2672 | 493 | 5.42 | 0.000 | 1.28 |
| Slime Weight | −1.500 | 0.573 | −2.62 | 0.010 | 1.14 |
| Iron | 1.347 | 0.736 | 1.83 | 0.069 | 1.20 |

Model Summary

| S | R-sq | R-sq(adj) | R-sq(pred) |
|---|---|---|---|
| 17.0431 | 34.17% | 31.14% | 27.30% |

The manufacturer worries that the sample size may not be large enough for the point estimates, R² or R², to have negligible random variation. As a result, the manufacturer may want to find a two-sided 95 percent confidence interval for ρ², the true proportion of the variation in the response (Feed Rate) that is explained by the regression model. Because the predictor variables do not deviate substantially from a multivariate normal distribution, the normal theory confidence intervals can be applied. But, for illustration purposes, the non-normal CI methods are also applied. The results show that the normal theory methods and the proposed methods yield very similar results as shown in Table 3.

TABLE 3
Lower confidence bounds 2
n = 160, p = 7, R² = 34.173%, Rₐ² = 31.142%, \hat{γ} = 2.175

| 95% Lower Confidence Bound | | 95% Lower Confidence Bound | |
|---|---|---|---|
| (Assuming normality) | | (Without Assuming Normality) | |
| | Normal | Adjusted F | Adjusted Normal |
| F | Approximation | Approximation | Approximation |
| Approximation | (New) | (New) | (New) |
| (19.147%, | (19.892%, | (19.331%, | (20.171%, |
| 43.383%) | 44.447%) | 42.824%) | 44.018%) |

Any specific manifestations of these and other similar example processes are not intended to be limiting to the invention. Any suitable manifestation of these and other similar example processes can be selected within the scope of the illustrative embodiments.

Thus, a computer implemented method, system or apparatus, and computer program product are provided in the illustrative embodiments for manufacturing based on confidence intervals for a population coefficient of multiple determination and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a dedicated measurement system 124 or user's computer, partly on the user's computer or measurement system 124 as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A method comprising:
reading, by a computing device, a dataset representative of a plurality of distribution agnostic measurements, the dataset comprising a plurality of observations, wherein each observation comprises a response variable value and a plurality of explanatory variable values;
fitting, by the computing device, a regression solver to the dataset to express the response variable value as a function of the plurality of explanatory variables;
computing, by the computing device, a sample coefficient of multiple determination based on the function;
compute, by the computing device, a kurtosis of a sample of fitted values;
output, by the computing device, a one- or two-sided confidence interval for a population coefficient of multiple determination
wherein the computing device is a confidence interval procedures engine.

2. The method of claim 1, generating the plurality of distribution agnostic measurements from one or more sensors in a manufacturing unit.

3. The method of claim 1, wherein the plurality of distribution agnostic measurements are generated automatically.

4. The method of claim 1, wherein the kurtosis of the sample of fitted values is computed using
$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} or \hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} ,$$
where the sample of fitted values are
wᵢ=xᵢ^{T}\hat{β}, i=1, . . . n, w̅ is the sample mean, and \tilde{w} is the sample median.

5. The method of claim 4, further comprising:
outputting the one- or two-sided confidence interval by computing, an approximate variance or first degrees of freedom for an F distribution based on the computed kurtosis.

6. The method of claim 5, wherein, wherein the approximate variance is computed using where
$${\hat{η}}^{2} = 2 \frac{( n - 3 ) p + 2 ( n - 1 ) ( n - 3 ) T + ( n - 1 ) ( n - 1 + \frac{n - p - 3}{\hat{d}} ) {T}^{2}}{{( n - 1 )}^{2} ( n - p - 5 ) {T}^{2}} \\ \hat{d} = \frac{2 n}{( n - 1 ) \hat{γ} - ( n - 3 )} \\ T = \frac{( n - 3 ) {R}^{2} - p}{( n - 1 ) ( 1 - {R}^{2} )}$$

7. The method of claim 5, wherein the first degrees of freedom for the F distribution are computed and is computed using where
$${δ}_{\hat{d}} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{\hat{d}} - 1 ) {ρ}^{4}} ,$$
where \hat{d}=2n/[(n−1)\hat{γ}−(n−3)].

8. A non-transitory computer-readable storage medium, the computer-readable storage medium including instructions that when executed by a computer, cause the computer to:
read, a dataset representative of a plurality of distribution agnostic measurements, the dataset comprising a plurality of observations, wherein each observation comprises a response variable value and a plurality of explanatory variable values;
fit, a regression solver to the dataset to express the response variable value as a function of the plurality of explanatory variables;
compute, a sample coefficient of multiple determination based on the function;
compute, a kurtosis of a sample of fitted values; and
output, a one- or two-sided confidence interval for a population coefficient of multiple determination.

9. The computer-readable storage medium of claim 8, wherein the plurality of distribution agnostic measurements are generating by from one or more sensors in a manufacturing unit.

10. The computer-readable storage medium of claim 8, wherein the kurtosis of the sample of fitted values is computed using
$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} or \hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}}$$
where the sample of fitted values are wᵢ=xᵢ^{T}\hat{β}, i=1, . . . n, w̅ is the sample mean, and \tilde{w} is the sample median.

11. The computer-readable storage medium of claim 10, wherein the instructions further configure the computer to:
output the one- or two-sided confidence interval by computing, an approximate variance or first degrees of freedom for an F distribution based on the computed kurtosis.

12. The computer-readable storage medium of claim 11, wherein the approximate variance is computed using
$${\hat{η}}^{2} = 2 \frac{( n - 3 ) p + 2 ( n - 1 ) ( n - 3 ) T + ( n - 1 ) ( n - 1 + \frac{n - p - 3}{\hat{d}} ) {T}^{2}}{{( n - 1 )}^{2} ( n - p - 5 ) {T}^{2}} \\ \hat{d} = \frac{2 n}{( n - 1 ) \hat{γ} - ( n - 3 )} \\ T = \frac{( n - 3 ) {R}^{2} - p}{( n - 1 ) ( 1 - {R}^{2} )}$$

13. The computer-readable storage medium of claim 11, wherein the first degrees of freedom for the F distribution are computed and is computed using
$${δ}_{\hat{d}} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{\hat{d}} - 1 ) {ρ}^{4}} ,$$
where \hat{d}=2n/[(n−1)\hat{γ}−(n−3)].

14. A computer system comprising:
a processor; and
a memory storing instructions that, when executed by the processor, configure the computer system to:
read, a dataset representative of a plurality of distribution agnostic measurements, the dataset comprising a plurality of observations, wherein each observation comprises a response variable value and a plurality of explanatory variable values;
fit a regression solver to the dataset to express the response variable value as a function of the plurality of explanatory variables;
compute a sample coefficient of multiple determination based on the function;
compute a kurtosis of a sample of fitted values;
output a one- or two-sided confidence interval for the population coefficient of multiple determination.

15. The computer system of claim 14, herein the instructions further configure the computer system to:
generate the plurality of distribution agnostic measurements from one or more sensors in a manufacturing unit.

16. The computer system of claim 14, wherein the kurtosis of the sample of fitted values is computed using
$$\hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}} or \hat{γ} = \frac{{\sum }_{i = 1}^{n} {( {w}_{i} - \overline{w} )}^{4}}{{[ {\sum }_{i = 1}^{n} {( {w}_{i} - \overline{w} )}^{2} ]}^{2}}$$
where the sample of fitted values are wᵢ=xᵢ^{T}\hat{β}, i=1, . . . n, w̅ is the sample mean, and \tilde{w} is the sample median.

17. The computer system of claim 16, wherein the instructions further configure the computer system to:
output the one- or two-sided confidence interval by computing, an approximate variance or first degrees of freedom for an F distribution based on the computed kurtosis.

18. The computer system of claim 17, wherein the approximate variance is computed using
$${\hat{η}}^{2} = 2 \frac{( n - 3 ) p + 2 ( n - 1 ) ( n - 3 ) T + ( n - 1 ) ( n - 1 + \frac{n - p - 3}{\hat{d}} ) {T}^{2}}{{( n - 1 )}^{2} ( n - p - 5 ) {T}^{2}}$$
$$where$$
$$\hat{d} = \frac{2 n}{( n - 1 ) \hat{γ} - ( n - 3 )} \\ T = \frac{( n - 3 ) {R}^{2} - p}{( n - 1 ) ( 1 - {R}^{2} )}$$

19. The computer system of claim 17, wherein the first degrees of freedom for the F distribution are computed and is computed using
$${δ}_{\hat{d}} = \frac{{[ ( n - p - 1 ) {ρ}^{2} + p ]}^{2}}{n - 1 - ( n - p - 1 ) {( 1 - {ρ}^{2} )}^{2} + ( n - 1 ) ( \frac{1}{\hat{d}} - 1 ) {ρ}^{4}} ,$$
where \hat{d}=2n/[(n−1)\hat{γ}−(n−3)].
